(19) United States
(12) Patent Application Publication
(10) Pub. No.: US 2020/0379930 A1
(43) Pub. Date: Dec. 3, 2020

(54) SYSTEM AND METHOD FOR TRANSFORMING LEGACY SR-IOV DEVICES TO APPEAR AS SIOV QUEUE PAIRS USING A MANAGEMENT CONTROLLER

(71) Applicant: Hewlett Packard Enterprise Development LP, Houston, TX (US)

(72) Inventors: PAUL V. Brownell, Houston, TX (US); Mitchel E. Wright, Houston, TX (US); William James Walker, Houston, TX (US)

(21) Appl. No.: 16/425,803

(22) Filed: May 29, 2019

(51) Int. Cl. G06F 13/20; G06F 13/42

(52) U.S. Cl. CPC G06F 13/20; G06F 13/4282; G06F 2213/0024; G06F 2213/0026; G06F 13/4204

(57) ABSTRACT

Methods and systems support bridging between end devices conforming to a legacy bus specification and a host processor using an updated bus specification, for example the latest PCIe specification or Compute Express Link (CXL). A hardware bridge can serve as an intermediary between the legacy I/O devices and the host processor. The hardware bridge has a hardware infrastructure and performs a hardware virtualization of the legacy I/O devices such that their legacy hardware is emulated by a virtual interface. The hardware bridge can surface the virtual interface to the host processor, enabling these I/O devices to appear to the host processor as an end device communicating in accordance with the updated bus specification. The hardware virtualization can involve emulating the I/O devices using scalable I/O Virtualization (SIOV) queue pairs, providing flexible and efficient translation between the legacy and updated specifications.

### DESCRIPTION OF RELATED ART

Computer systems employ a wide variety of peripheral components or input/output (I/O) devices. For example, a typical computer system usually contains a monitor, a keyboard, a mouse, a network controller, a disk drive or an array of disk drives, and, optionally, a printer. High performance computer systems such as servers have more complex I/O device requirements.

An example of a host processor of a computer system connected to I/O devices through a component bus is defined by the PCI (peripheral component interconnect) Local Bus Specification, published by the PCI Special Interest Group. During system initialization, the host processor loads a device driver for each PCI device on the PCI bus. A typical PCI device includes multiple configuration registers located within a configuration memory space of each respective PCI device. The configuration registers including identification registers, such as, for example, the vendor ID, device ID or revision register, are read by the device driver and the host system during the initialization or normal operations to identify the PCI device. Typically, the identification registers are hardwired to fixed values during the manufacturing processes of the PCI device and they are not modifiable by the device driver or the operating system (OS) of the host. As a result, a legacy device driver that is looking for specific identification of a PCI device will not work with a PCI device having different identification information, such as, a different vendor ID or a different device ID, etc.

PCI Express (PCIe) is an improvement over PCI and defines a high performance, general purpose I/O interconnect for a wide variety of computing and communications platforms. Key PCIe attributes, such as the PCI usage model, load-store architectures, and software interfaces, are maintained in PCIe, but PCI's parallel bus implementation is replaced in PCIe with a highly scalable, fully serial interface. PCIe takes advantage of advanced point-to-point interconnects, switch-based technology, and packetized protocols to deliver improved performance features.

While computing and communications systems incorporating PCIe technology are proliferating, many legacy (e.g., PCI) systems remain in use. Even further, advancements in the industry are also causing the specifications of PCIe to evolve, such that devices that are designed to interface with older PCIe standards may be considered legacy PCIe systems. When such legacy systems (e.g., PCIe and PCI) are mated to the newer PCIe systems, communications between these legacy systems and the newer PCIe systems can create problems.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example of a bridging system including a bridge implemented using a hardware infrastructure and facilitating communication between a Peripheral Component Interconnect Express (PCIe) enabled host and legacy PCIe end devices, according to some embodiments.

FIG. 2 is a conceptual diagram of an example of a bridging system including a bridge implemented using a hardware infrastructure and facilitating communication between a Compute Express Link (CXL) enabled host and a legacy PCIe end device, according to some embodiments.

FIG. 3 is an operational flow diagram illustrating an example of a process for virtualizing legacy PCIe devices to appear as PCIe enabled device, according to some embodiments.

FIG. 4 illustrates an example computer system that may be used in bridging a PCIe enabled host to legacy PCIe end devices relating to the embodiments of the disclosed technology.

The figures are not exhaustive and do not limit the present disclosure to the precise form disclosed.

### DETAILED DESCRIPTION

Various embodiments described herein are directed to methods and systems for transforming legacy I/O devices and SR-IOV devices to be able to communicate with a host that is employing an updated bus specification, such as a Peripheral Component Interconnect Express (PCIe) specification that has been updated with respect to a legacy PCIe specification. The embodiments include a hardware bridge that acts as an intermediary between the legacy I/O devices and the host, and performs hardware virtualization in manner that allows the legacy I/O devices to appear as devices conforming to the latest PCIe specification from the perspective of the host.

As specifications and standards for buses, such as PCIe, continue to change, the interfaces of devices that are coupled to these buses also change to support interoperability. For example, there are several enhancements to PCIe that have been designed to provide additional feature sets and improve performance. However, from the time new PCIe specifications are deployed and used in the industry, there may be a lag in the development of up-to-date hardware that conforms to these new specifications at the bus-level. In a real-world example, a company may not have the capital or time to devote to the development life cycle for new I/O cards. As a consequence, widespread compatibility of devices to the newest PCIe may lag. Scenarios may arise where a new PCIe system may be connected to legacy devices that do not have hardware that is up-to-date and thus cannot interface with the newest PCIe specifications. The disclosed system can address these drawbacks, and function as a hardware bridge in-between legacy devices and a host system. The hardware bridge can surface a newer PCIe interface to the host system, while allowing the legacy devices to bridge to an older interface. Accordingly, the disclosed system enables interoperability between host systems (compatible with the newest PCIe specification) and legacy devices (not compatible with the newest PCIe specification) without requiring modifications at either end.

In the following description, a system comprised of mutually connected devices in PCI Express will be referred to as PCIe system, several kinds of devices to be connected will be referred to as PCIe devices, a bus for connecting the devices will be referred to as PCIe bus, and packets for use in communication will be referred to as PCIe packets. A system that uses technology prior to PCIe or uses an older PCIe specification will be referred to as a legacy systems and will have corresponding legacy devices and buses.

Input/Output Virtualization (IOV) is a name given to the capability of an I/O device to be used by more than one operating system (OS—sometimes called a system image) running on the same or different CPUs. Modern computing and storage systems use IOV because IOV offers improved management of information technology resources through load balancing and effective use of underutilized resources. For example, IOV allows a limited set of resources, such as computer memory, to be more fully used, with less idle time, by making that resource available on a shared basis among a number of different operating systems. Thus, instead of having separate memory for each OS, where each separate memory is underused, a shared memory is available to all operating systems and the shared memory experiences a higher utilization rate than that of any of the separate resources.

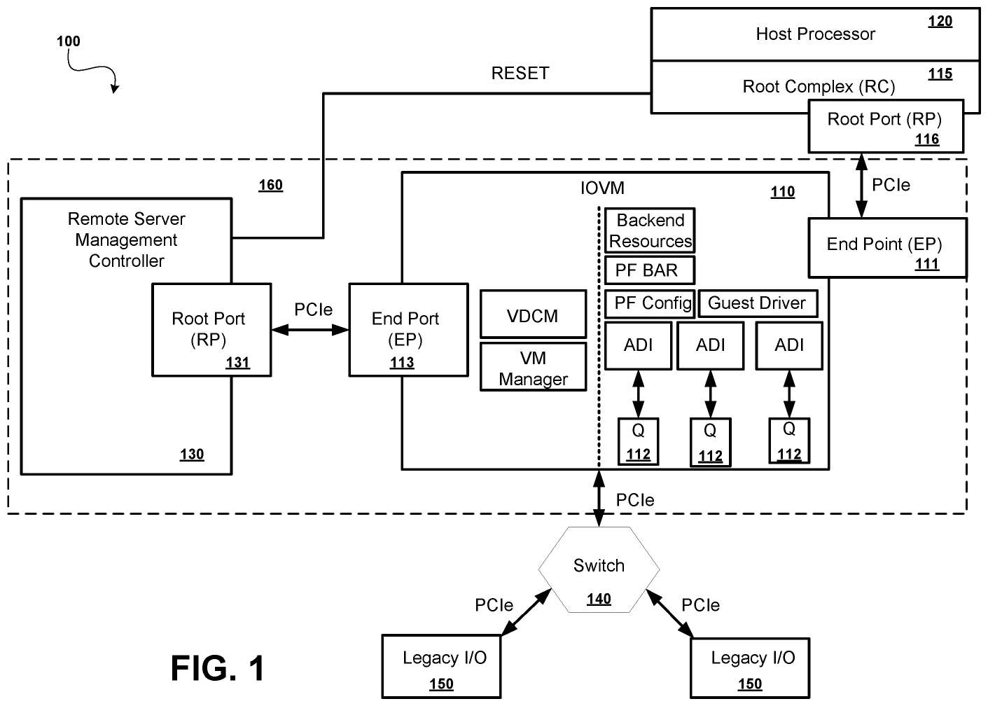

Now referring to FIG. 1, the example system 100 includes a hardware bridge 160 that is situated between a host processor 120 and multiple end devices, shown as legacy I/O devices 150. FIG. 1 illustrates that the hardware bridge 160 is referred to as a “logical” single device, including both local and remote elements (grouped together as a logical device represent by dashed lines). As previously described, a scenario relating to system 100 can involve the host processor 120 being properly updated for connecting to (and interfacing with) a bus in accordance with a new specification of PCIe. However, the host processor 120 may be coupled to end devices that include hardware, such as I/O cards, that is still configured for a legacy PCIe specification. Accordingly, the disclosed hardware bridge 160 serves as an intermediary between the legacy PCIe and PCIe mismatch, facilitating initialization and communication between the legacy I/O devices 150 and the host processor 120 using virtualization and abstraction of the underlying hardware of the end devices (from the perspective of the host processor 120).

As seen in FIG. 1, the system includes a host processor 120 and a root complex (RC) 115. The hardware bridge 160 is coupled to the host processor 120 through the RC 112 via the root port (RP) 116. The RC 115 can serve as a “root” of a tree topology of PCIe, a PCIe switch 140 that provides a fan-out function to a PCIe bus, and devices that are connected via the PCI bus, shown as legacy I/O devices 150. The host processor 120 may be a general purpose processor, an embedded processor, or a specialized processing element. In general, the side of the root complex 115 adjacent to the host processor 120 of the tree topology of PCIe is referred to as upstream, and that adjacent to the I/O devices 150 is referred to as downstream. While in FIG. 1, two legacy I/O devices 150 are connected to the PCIe switch 140, the number of the legacy I/O devices 150 that can be connected is not limited to two. Configuration software can be provided in the host processor 120 for configuring the PCIe system 100.

Additionally, the legacy I/O devices 150 may be implemented as other types of end devices, for example single root input/output virtualization (SR-IOV) devices. SR-IOV is a PCIe specification that defines a new type of function called a virtual function. Virtual functions have some significant differences from prior (legacy) PCI functions, and require changes in the PCI code of any host to which SR-IOV devices would attach. As an alternative to changing the PCI code of the host, the virtual functions may be made to look like regular PCI functions. This transformation is effected as part of the configuration process executed by a PCI host. The transformation is executed in an intermediate device that resides between the host and the virtual function.

Each of the legacy I/O devices 150 are coupled to switch 140. The PCIe switch 140 comprises an upstream PCI-PCI bridge, an internal PCI bus, and downstream PCI-PCI bridges (components now shown). The upstream PCI-PCI bridge and downstream PCI-PCI bridges comprise respective configuration registers for retaining information on PCIe resource spaces connected downstream of the respective bridges. The PCIe resource spaces are spaces occupied under several addresses used in a PCIe system. Furthermore, the switch 140 allows the hardware bridge 160 to connect to multiple legacy I/O devices 150 via a PCIe bus.

FIG. 1 illustrates that the hardware bridge 160 is implementing using a hardware infrastructure (as oppossed to software infrastructure), including a remote management controller 130 and I/O Virtualization Manager (IOVM) 110. As an example, the remote server management controller 130 can be implemented as hardware device, such as server computer that is separate from the IOVM 110. Furthermore, the IOVM 110 can be implemented as a hardware element, such as an application-specific integrated circuit (ASIC). As a general description, the remote management controller 130 is configured to perform I/O discovery and scalable I/O virtualization (SIOV) while the host processor 120 is in the reset state. Control of configuration, management, and security can be given to the IOVM 110 as directed by the remote server management controller 130. Therefore, the IOVM 110 (working in concert with the remote server management controller 130) can provide the bridging between the legacy I/O devices 150 and the host processor 120. Without the functionality provided by the hardware bridge 160, the data path to the legacy I/O devices 150, from the perspective of the host processor 120, would appear as a transparent bridge. Continuing with that scenario, a “transparent” bridge between the host processor 120 and the legacy I/O devices 150 the would not provide much functionality. For example, a “transparent” bridge would transfer all of the activity directly to legacy I/O devices 150. In other words, the “transparent” bridge between the host processor 120 and the legacy I/O devices 150 would be “unseen”, in a sense that all of the operations pass though.

A legacy I/O device 150, including a legacy PCIe I/O card, typically has several functions related to configuration operations. During independent configuration cycles, each of the legacy I/O devices 150 can set up its respective I/O card, providing resources and management of the cards. In some existing bridge configurations (e.g., where remote server management controller 130 is not present), the legacy I/O devices 150 would have to surface its interface of queues presented by the legacy PCIe cards, directly to the host processor 120. For example, these queues of the legacy I/O devices 150 would be in a base address range (BAR), which would be surfaced to the host processor 120. However, according to the embodiments, the PCIe system 100 shown in FIG. 1 allows the legacy I/O devices 150 to surface its queues to the host processor 120 vis-a-vis the remote management controller 130.

In particular, instead of surfacing the queues (used for data transmission) presented by the legacy I/O devices 150 through the data path until reaching the host processor 120, the IOVM 110 stops the surfacing at the end point (EP) 111 prior to reaching the host processor 120. At the IOVM 110, the queues of the legacy I/O devices 150 are transformed in order to conform to the latest specification of PCIe that is currently being used by the host processor 120. The bridge can then surface the new queues in accordance with the new PCIe specification, which is referred to herein as virtual interface. Accordingly, the IOVM 110 can provide a virtual interface for the legacy I/O devices 150 (where the virtual interface is compliant with the new PCIe specification) that otherwise would suffer from incompatibility to the host processor 120 using their legacy PCIe cards as an interface. In some instances, these queues have a light design, meaning that the queues have less management overhead managing and improved performance. Thus, using a queue-based implementation to bridge between the host processor 120 and the legacy I/O devices 150 allows for the IOVM 110 to function efficiently, and without injecting a significant delay in the initialization process.

In FIG. 1, the host processor 120 is connected to the IOVM 110, allowing the IOVM 110 to serve as an intermediary downstream to the legacy I/O devices 150. Thus, in this arrangement, the host processor 120 can “see” the virtual interface provided by the IOVM 110, as opposed to “seeing” the legacy PCIe cards of the legacy I/O devices 150. The IOVM 110 enables the host processor 120 to “see” the virtual interface by presenting the queues 112 to the host processor 120 though the bridge, which is fed by the legacy I/O devices 150.

Another important aspect of the disclosed system 100 relates to the concept of hardware virtualization. As referred to herein, hardware virtualization can be described as the act of creating a virtual (rather than actual) version of hardware, in a manner that allows certain logical abstractions of the hardware's componentry, or the functionality of the hardware to be emulated completely using another hardware platform as the conduit. Virtualization can hide certain physical characteristic of hardware, in this case abstracting away aspects of the I/O devices 150 that are specific to legacy PCIe (e.g., legacy PCIe cards), and presenting instead a generic component that can be translated into hardware operating using a desired bus specification, for instance a newest PCIe. By leveraging hardware virtualization, the system 100 can realize various improvements over some traditional bridges that employ a software infrastructure to achieve the virtualization. System 100 employs a hardware infrastructure, namely the IOVM 110 and the remote server management controller 130, in order to surface the legacy PCIe interfaces of the legacy I/O devices 150 as a virtual interface seen by the host 120 using hardware virtualization. For example, the IOVM 110 uses hardware queues 112 and hardware state machines to implement the virtual interface as disclosed herein. As alluded to above, traditional bridges may use software to manage and perform the data transfer between legacy systems and new systems. However, in the system 100, the remote server management controller 130 and IOVM 110 perform these functions to emulate, or virtualize, the legacy I/O devices 150 using new specification queues.

Another aspect of the system 100 is a separation of the management functions, such that managing the legacy I/O devices 150 is performed out-of-band (with respect to the data path between the host 120 and the legacy I/O devices 150). In some traditional bridging systems, the host processor 120 would manage any hardware devices connected thereto by communicating management information (setting up the parameters, memory ranges, addresses ranges, and so on) directly through the data path to the legacy I/O devices 150. However, legacy I/O devices 150 do not control error operations, which can lead to vulnerabilities when the host processor 120 communicates directly with a potentially faulty legacy I/O devices 150 during initial management stages. A situation may arise where a legacy I/O device 150 is operating outside of its intended functionality. For instance, the direct memory access (DMA) of a legacy I/O device 150 may be malfunctioning or may be re-programmed by malicious software (e.g., malware). In this case, a traditional bridge system would allow the compromised legacy I/O device 150 to access the host processor 120 (e.g., leaving memory of the host processor 120 vulnerable to malicious reads and/or writes), while it is managing the devices for set-up.

In another example, a legacy I/O device 150 may have a software bug or any type of error, flaw, failure or fault in the hardware system that causes it to produce an incorrect or unexpected result, or to behave in unintended ways. Again, in a traditional bridge system (where the host processor 120 would use the data path downstream to the legacy I/O devices 150 for management functions) there exits the potential of harming the host process 120 in directly accessing the legacy I/O devices 150 for management. For instance, a bug can cause the legacy I/O device 150 to overwrite the OS of the host processor 120, exaccerbatting any problems resulting from the glitch at the I/O device and being characteristically difficult to debug. Generally, there are security risks associated with the host processor 120 directly managing the legacy I/O devices 150 in the manner of some existing bridge systems as previously described. Nonetheless, the disclosed system 100 employs the remote server management controller 130 for managing the legacy I/O devices 150 and the bridge. In this configuration, the remote server management controller 130 can serve as a separate management plane between the legacy I/O devices 150 and the host processor 120 which helps mitigates many of the risks related to in-band management of legacy I/O devices 150. Even further, the remote server management controller 130 has the capability to manage the particular locations in the hosts' 120 memory that are accessible to the legacy I/O devices 150 for read and/or writes. Additionally, the remote server management controller 130 can actively restrict access that the legacy I/O devices 150 have to the host processor 120 through the management plane.

As illustrated in FIG. 1, the remote server management controller 130 can be considered out-of-band with respect to the data path bridging the host processor 120 to the legacy I/O devices 150. As such, for management functions in system 100, the data is transferred through a stream that is independent from the main in-band data stream from the host processor 120 downstream (through the switch 140) to the legacy I/O devices 150. The remote management controller 130 operates as an out-of-band mechanism providing an independent channel to the host processor 120, which allows any data sent from the legacy PCIe cards at the legacy I/O devices 150, for example, via the remote server management controller 130 to be kept separate from the in-band data in the principal data path. The separate management at the remote server management controller 130 does not impact the perspective of the host processor 120, which continues to “see” the virtual interface presented from the bridge in accordance with the latest PCIe specification. Thus, the host processor 120 can manage the legacy I/O devices 150 by interacting with the virtual interface in a fashion that does not require consideration of the details of the physical hardware below, namely the legacy I/O devices 150.

By applying the aforementioned out-of-band management approach during an initial configuration, the remote server management controller 130 can enumerate and set-up the legacy PCIe cards, for instance, of the legacy I/O devices 150. Subsequently, the remote server management controller 130 can maintain all of the management and set-up of these legacy I/O devices 150. In some embodiments, these management functions are performed by the remote server management controller 130 while the host processor 120 is in reset (represented in FIG. 1 by “RESET”). As an example, during reset of the host processor 120, the remote server management controller 130 can be up and functional, initializing the legacy I/O cards at the legacy I/O devices 150 to be ready for operation. The remote server management controller 130 can direct the IOVM 110 to examine the legacy I/O devices 150, assign Remote Machine Memory Addresses (RMMA) space, and determine which memory bindings should establish working open fabric Remote Direct Memory Access (RDMA) and queues pairs (Q) 112. Once an initial configuration has been set, the remote server management controller 130 can allow the host processor 120 out of reset. At this point, the IOVM 110 presents the queues 112, Physical Function (PF) Base Address Registers (BAR), and configuration information to the host processor 120. In response to taking the host processor 120 out of reset, the legacy PCIe cards of the legacy I/O devices 150 will be ready for operation, and the virtual interface surfaced by the bridge will be initialized and ready for the host processor 120 to communicate to them using the PCIe bus in accordance with the new specification.

It should be appreciated that although the system, elements, and functionality disclosed herein are discussed in reference to PCIe technology, that the system is not intended to be limited to PCIe system exclusively. For instance, the system 100 can be applied to the emerging Compute Express Link (CXL) standard for high-speed CPU-to-device interconnect. The CXL technology is built upon the PCIe infrastructure, leveraging the PCIe 5.0 physical and electrical interface to provide advanced protocol in key areas, such as: input/output protocol, memory protocol, and coherency interface. Consequently, the bridge, as disclosed herein, has utility that can be extended across various bus standards and specifications. System 100 can provide a compatibility between legacy devices and the latest enhancements to the PCIe specification, and various other evolving technologies relating to bus, interface, and interconnects, such as CXL. contrast, in some traditional bridging systems, all of the management functions are run on the host processor 120. Then, the host processor 120 would be responsible for managing each of the legacy endpoints, namely legacy I/O devices 150 through a driver (running on the host 120) and its Basic Input/Output System (BIOS). When the traditional bridging system boots up, the BIOS would perform enumeration (e.g., before the OS runs) and execute the configuration cycles that involve scanning the buses for device discovery, set-up, and resource allocation. However, in the disclosed system 100, these aforementioned functions that would otherwise be delegated to the host system 120 in existing bridging systems are all capabilities of the remote server management controller 130 that are performed while the host processor is being reset. After the host processor 120 comes out of reset, the hosts' 120 BIOS can function similarly as it does in traditional bridging systems, but the legacy I/O devices 150 will appear as the virtual interface that is surfaced to it from the bridge.

During operation, communication between the host processor 120 and the legacy I/O devices 150 does not traverse the bridge, including the IOVM 110, transparently (as in some existing bridging systems) through the entire data path. In system 100, the IOVM 110 can stop communication at one of its end points (EP) 111, 113. Moreover, as a security aspect, the IOVM 110 can also terminate communication at its end points (EP) 111, 113 if deemed appropriate.

In some cases, the legacy I/O devices 150 are associated with a vendor ID. As referred to herein, a vendor can be a company that is associated with the manufacture, design, or sell of the legacy I/O devices 150. Also, each of the respective PCIe cards for the legacy I/O devices 150 can be associated with the unique vendor ID (corresponding to its device). The legacy I/O devices 150, in an example, may be allocated a vendor ID that is specific to Hewlett Packard Enterprise™. In some embodiments, the IOVM 110 can be configured to utilize various types of identifying data relating to the legacy I/O devices 150, such as vendor IDs, in surfacing the devices 150 to the host processor 120. Referring back to the example, the IOVM 110 can surface an HPE™ vendor ID to the host processor 120. Even further, the IOVM 110 may surface the legacy I/O devices 150 as having a HPETM vendor ID to ensure compatibility with the PCIe standard used by the host processor 120 (although the queues that would be surfaced to the host 120 would be originating from a different vendor, thereby having a non-HPE vendor ID). The disclosed bridge has the flexibility to control, or otherwise adapt, the manner in which the legacy I/O devices 150 appear to the host processor 120 via the virtual interface.

Thus, the bridge implements a management plane that allows an external management controller to configure and manage the legacy I/O devices 150 in a form that allows the bridge to surface the legacy I/O cards as the newer I/O interfaces. The IOVM method improves on the standard SIOV performance because it is a “bare metal” application. The IOVM also enables tunneling and encapsulation for greater scalability, and heightens security by preventing the host processor 120 from directly accessing the legacy I/O devices 150.

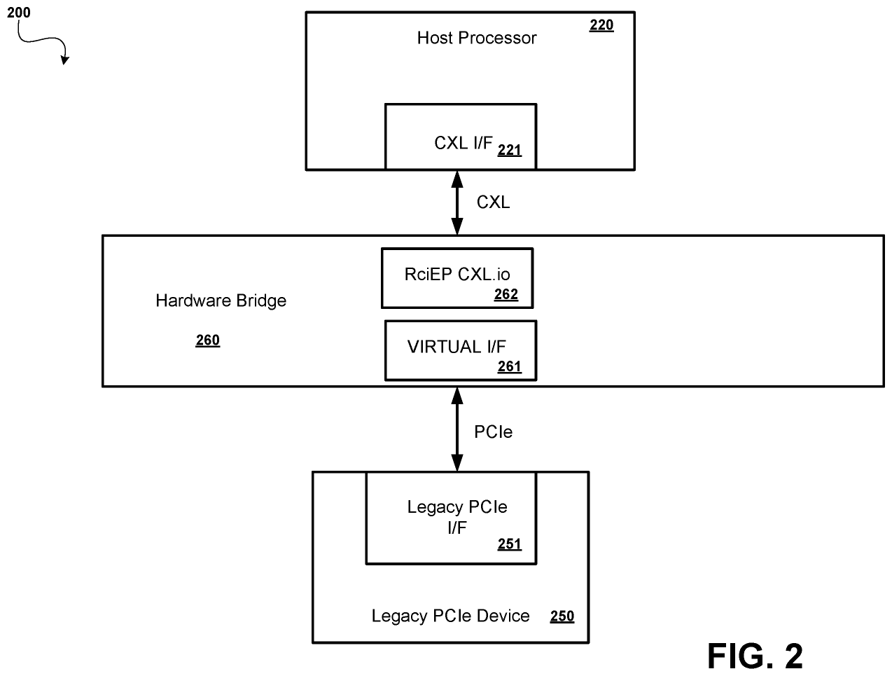

Referring now to FIG. 2, an example of another system 200 including the disclosed hardware bridge 260 is shown. The hardware bridge 260 can be used to virtualize legacy PCIe end devices to appear as devices employing various other bus standards, such as CXL as alluded to above. In this example, the hardware bridge 260 performs hardware virtualization of a legacy PCIe device 250 that is still using legacy hardware, namely a legacy PCIe interface (I/F) 251 and a PCIe connection. In accordance with the embodiments, the hardware bridge 260 has a flexibility which allows the legacy PCIe device 250 to be surfaced to the host processor 220 in a manner deemed appropriate for the particular application. In this example, the host processor 220 is coupled to the hardware bridge 260 via a CXL bus, and includes an interface, CXL I/F 221, which conforms to the CXL standard. The CXL I/F 221 at the host 220 can be connected to an CXL interface at the hardware bridge, shown as RCiEP CXL.io 262. The CXL I/F 262, implemented as RCiEP, can be a root complex integrated end point. Consequently, the hardware bridge 260 can present a virtual interface 261 that can transfer data in accordance with the CXL bus standard that is being employed by the host system 220.

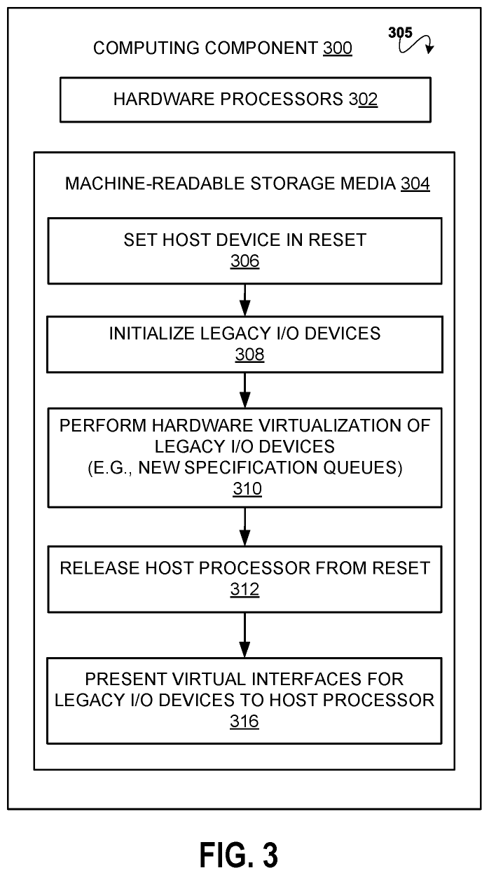

FIG. 3 is an operational flow diagram illustrating an example of a process 305 for virtualizing legacy PCIe end devices to appear as PCIe enabled devices to a host coupled thereto. As discussed above, a host computer may employ an updated bus specification, such as the latest PCIe specification (e.g., specification that has been updated or is newer with respect to a legacy PCIe specification). Furthermore, FIG. 3 shows process 305 as a series of executable operations stored on machine-readable storage media 304 and performed by hardware processor 302, which can be the main processor of a computer device, for example the remote server management controller (shown in FIG. 1). Processor 302 executes the operations of process 305, thereby implementing the disclosed techniques.

The process can begin at an operation 306, where a host computer is placed into reset. For example, upon start of a PCIe-based system (shown in FIG. 1), a remote server management controller can place the host computer into reset. The remote management controller may place the host device in reset in response to sensing an active connection/disconnection of a plug of an I/O device to/from a slot via a PCIe bus. For example, the remote server management controller may detect that a legacy I/O device is physically plugged into a switch (to be ultimately coupling to the host computer). Placing the host computer in a reset state allows the remote server management controller to take control over the I/O discovery functions that would otherwise be performed by the host device (e.g., during configuration).

Next, while the host computer is in reset, the process 305 can proceed to operation 310. At operation 310, the legacy I/O devices, such as legacy PCIe, can be initialized as directed by the remote server management controller. The remote server management controller may hand control over to the IOVM, enabling I/O device discovery to be performed by the “bridge”, as oppossed to the host computer. The IOVM can perform configuration cycles where each of the legacy I/O devices present in the PCIe system are searched for and discovered. For example, each slot in every PCI bus may be checked for the attribute of a legacy I/O devices occupying the slot.

Thereafter, the IOVM can perform hardware virtualization of the legacy I/O devices at operation 310. As previously described, hardware virtualization in accordance with the embodiments can involve abstracting details of the underlying hardware relating to the legacy I/O devices, such as the their I/O interfaces, in order to provide a virtual version of these devices to the host device. Operation 310 can involve the SIOV performing multiple tasks relating to achieving scalable hardware virtualization of the legacy devices, including, but not limited to: assigning Remote Machine Memory Addresses (RMMA) space; determining which memory bindings should establish working open fabric Remote Direct Memory Access (RDMA); and managing queues pairs. For example, the IOVM can have a queue corresponding to a legacy I/O device in its legacy PCIe specification, and another queue that is translated into the new PCIe specification being used by the host computer. Thus, the queue pairs can function as a virtual interface, allowing legacy PCIe device to appear as new PCIe specification-enabled end device.

Once the configuration of the legacy I/O devices has been completed by the IOVM, the remote server management controller can release the host processor from reset in operation 312. In some instances, in response the host computer being out of reset, the host computer may begin its own I/O device discovery process (e.g., BIOS operation). However, the configuration cycles initiated by the host device can be captured by the hardware bridge, acting as an intermediary. Accordingly, the IOVM can present the virtual interfaces, vis-a-vis the queue pairs, to the host computer at operation 316.

During operation 316, the hardware bridge can surface a virtual interface corresponding to each of the coupled legacy I/O devices to the host computer. As a result, the physical interfaces at the legacy I/O devices have already been initialized by the IOVM, and are and ready for the host computer to communicate with them using the virtual interface (even during initial discovery) using the new PCIe specification, for example. Furthermore, as described above, a queue at the IOVM is used to transfer data in accordance with the bus specification used by the host device. For example, a queue corresponding to a legacy PCIe device can communicate data in accordance with the CXL standard and acting a virtual interface with the host computer. Thus, legacy I/O devices appear to the host computer as having up-to-date hardware (e.g., I/O interface cards), without having to revert to an older specification (e.g., losing out on the benefits related to enhanced newer specifications) or modifying the out-of-date hardware at the legacy end devices. In some cases, operation 314 includes the IOVM presenting the BAR, and any configuration information that is deemed appropriate to the host device.

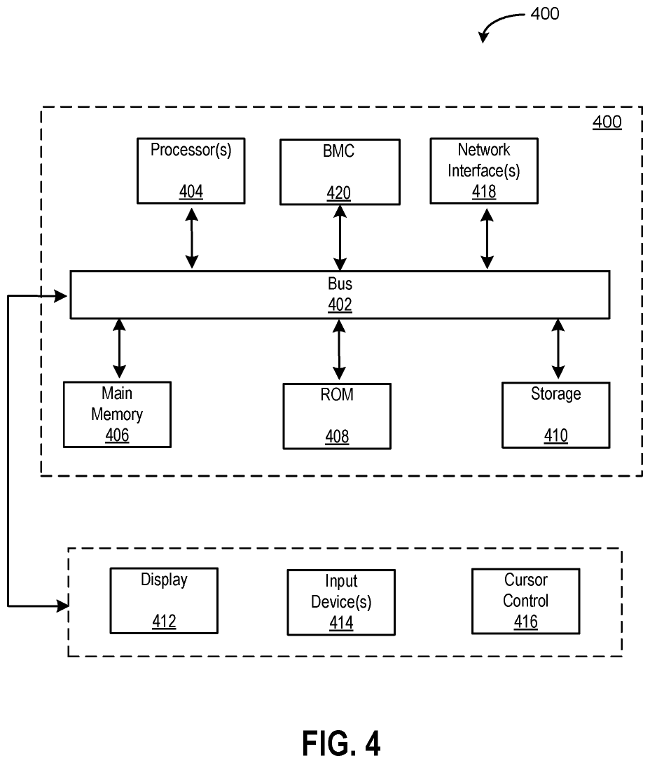

FIG. 4 depicts a block diagram of an example computer system 400 that may be in bridging a PCIe enabled host to legacy PCIe end devices, as disclosed herein. The computer system 400 includes a bus 402 or other communication mechanism for communicating information, and one or more hardware processors 404 coupled with bus 402 for processing information. Hardware processor(s) 404 may be, for example, one or more general purpose microprocessors.

The computer system 400 also includes a main memory 408, such as a random-access memory (RAM), cache and/or other dynamic storage devices, coupled to bus 402 for storing information and instructions to be executed by processor 404. Main memory 408 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions. The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor 404 may be programmed by one or more additional instructions that may perform some or all of the functionality attributed herein to one of the instructions.

The computer system 400 further includes storage device 410. The various instructions described herein, including the ADC list concatenation techniques, may be stored in a storage device 410, which may comprise read only memory (ROM), and/or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions. The storage device 410 may store the computer program instructions (e.g., the aforementioned instructions) to be executed by processor 404 as well as data that may be manipulated by processor 404. The storage device may comprise one or more non-transitory machine-readable storage media such as floppy disks, hard disks, optical disks, tapes, or other physical storage media for storing computer-executable instructions and/or data.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 408. Such instructions may be read into main memory 408 from another storage medium, such as storage device 410. Execution of the sequences of instructions contained in main memory 408 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 608. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a communication interface 418 coupled to bus 402. Network interface 418 provides a two-way data communication coupling to one or more network links that are connected to one or more local networks. For example, communication interface 418 may be an integrated service digital network (ISDN) card, cable modem, satellite modem, or a modem to provide a data communication connection to a corresponding type of telephone line. As another example, network interface 418 may be a local area network (LAN) card to provide a data communication connection to a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. Wireless links may also be implemented. In any such implementation, network interface 418 sends and receives electrical, electromagnetic or optical signals that carry digital data streams representing various types of information. The nodes of the decentralized model building system, as disclosed herein, may be coupled to other participant nodes via the abovementioned networks.

A network link typically provides data communication through one or more networks to other data devices. For example, a network link may provide a connection through local network to a host computer or to data equipment operated by an Internet Service Provider (ISP). The ISP in turn provides data communication services through the world-wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 400 can send messages and receive data, including program code, through the network(s), network link and communication interface 418. In the Internet example, a server might transmit a requested code for an application program through the Internet, the ISP, the local network and the communication interface 418.

The received code may be executed by processor 404 as it is received, and/or stored in storage device 410, or other non-volatile storage for later execution.

The various processes, methods, operations and/or data flows described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 400.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
initializing one or more input/output (I/O) end devices communicating in accordance with a legacy bus specification, wherein the initializing is performed while a host processor is in a reset state;
performing hardware virtualization of the one or more I/O end devices to emulate a virtual interface corresponding to each of the one or more I/O end devices, wherein each virtual interface enables the corresponding I/O devices to appear to the host processor as an end device communicating in accordance with an updated bus specification;
presenting each virtual interface corresponding to the one or more I/O end devices to the host processor, wherein the presenting is performed while the host is released from the reset state.

2. The method of claim 1, wherein performing hardware virtualization comprises:
emulating a physical interface at each of the one or more I/O end devices using a queue that conforms to data transmission in accordance with the updated bus specification.

3. The method of claim 2, wherein the physical interface at each of the one or more I/O end devices conforms to data transmission in accordance with the legacy bus specification.

4. The method of claim 2, wherein the virtual interface comprises a scalable I/O virtualization (SIOV) queue pair corresponding to each of the one or more I/O end devices.

5. The method of claim 4, wherein a first queue in the SIOV queue pair conforms to data transmission in accordance with the legacy bus specification and a second queue in the SIOV queue pair emulates the physical interface in accordance with the updated bus specification.

6. The method of claim 5, wherein presenting each virtual interface comprises:
surfacing the second queue in the SIOV queue pair to the host processor in accordance with the updated bus specification to function as a bridge enabling communication between the one of more I/O devices and the host processor.

7. The method claim 1, wherein the legacy bus specification comprises a legacy Peripheral Component Interconnect Express (PCIe) specification.

8. The method claim 1, wherein the legacy bus specification comprises a legacy Peripheral Component Interconnect (PCI) specification.

9. The method claim 7, wherein the updated bus specification comprises a PCIe specification that has been updated with respect to the legacy PCIe specification.

10. The method of claim 1, wherein the updated bus specification comprises a Compute Express Link (CXL) specification.

11. A system comprising:
a hardware bridge;
one or more input/output (I/O) end devices coupled to the hardware bridge via a first bus conforming to a legacy bus specification; and
a host processor coupled to the hardware bridge via a second bus conforming to an updated bus specification, and
wherein the hardware bridge acting as an intermediary between the host processor and the one or more I/O end devices performs:
initializing the one or more input/output (I/O) end devices communicating in accordance with the legacy bus specification, wherein the initializing is performed while the host processor is in a reset state;
performing hardware virtualization of the one or more I/O end devices to emulate a virtual interface corresponding to each of the one or more I/O end devices, wherein each virtual interface enables the corresponding I/O devices to appear to the host processor as an end device communicating in accordance with an updated bus specification;
presenting each virtual interface corresponding to the one or more I/O end devices to the host processor, wherein the presenting is performed while the host is released from the reset state.

12. The system of claim 11, wherein the hardware bridge comprises a hardware infrastructure.

13. The system of claim 12, wherein the hardware bridge comprises:
a remote server management controller that is out of the data path between the one or more I/O end devices and the host processor; and
an I/O Virtualization Manager (IOVM) that is in the data path between the one or more I/O end devices and the host processor.

14. The system of claim 11, wherein each of the one or more I/O end devices comprises a physical interface that conforms to data transmission in accordance with the legacy bus specification.

15. The system of claim 14, wherein the physical interface is a legacy Peripheral Component Interconnect Express (PCIe) card and the is legacy bus specification is a legacy PCIe specification and the first bus is a PCIe bus.

16. The system of claim 15, wherein the host processor comprises an interface that conforms to data transmission in accordance with the updated bus specification.

17. The system of claim 16 , wherein the updated bus specification comprises a PCIe specification that has been updated with respect to the legacy PCIe specification and the second bus is a PCIe bus.

18. The system of claim 16, wherein the updated bus specification comprises a Compute Express Link (CXL) specification and the second bus a CXL bus.

19. The system of claim 14, wherein the hardware bridge further performs:
emulating the physical interface at each of the one or more I/O end devices using a queue that conforms to data transmission in accordance with the updated bus specification.

20. The system of claim 19, wherein the hardware bridge further performs:
surfacing the queue to the host processor in accordance with the updated bus specification to function as a bridge enabling communication between the one of more I/O devices and the host processor.
